(19) United States
(12) Patent Application Publication
(10) Pub. No.: US 2005/0285564 A1
(43) Pub. Date: Dec. 29, 2005

(54) AUTOMATIC CHARGING OF A HIGH VOLTAGE BATTERY IN A HYBRID ELECTRIC VEHICLE

(75) Inventors: Jacob Mathews, Canton, MI (US); Raymond Siciak, Ann Arbor, MI (US); Patrick Maguire, Ann Arbor, MI (US); Christopher Ochocinski, Canton, MI (US); Tony Lockwood, Westland, MI (US)

Correspondence Address: BROOKS KUSHMAN P.C./FGTL, 1000 TOWN CENTER, 22ND FLOOR, SOUTHFIELD, MI, 48075-1238, US

(73) Assignee: FORD GLOBAL TECHNOLOGIES, LLC, Dearborn, MI (US)

(21) Appl. No.: 10/710,211

(22) Filed: Jun. 25, 2004

(51) Int. Cl. H02J 7/00

(52) U.S. Cl. 320/116

(57) ABSTRACT

The present invention provides an automatic battery charging system for selectively charging a battery in a vehicle. The automatic charging system includes a charger capable charging a first battery in a vehicle. Coupled to the charger is a controller that determines whether or not the first battery requires electrical charging. If charging is required, the controller causes the charger to automatically provide the first voltage signal to the first battery without intervention from a user. The present invention also provides a method of charging a battery in a vehicle which is executed by the automatic battery charging system of the invention.

### BACKGROUND OF INVENTION

1. Field of the Invention

The present invention relates to a system and method for charging a battery in a vehicle. More particularly, the present invention relates to a system and method for charging the high voltage battery in a hybrid electric vehicle.

2. Background Art

Governmental regulations and environmental concerns have dictated the need for automobile manufacturers to develop more fuel efficient power trains. All-electric and hybrid electric powertrains are two examples of such powertrains currently under development. Although all electric vehicles are desirable in that such vehicles offer the potential to be simply regenerated by plugging into a power outlet and may completely eliminate fossil fuel dependence, even after many years of research these vehicles are currently limited by current technology and only have a limited distance range. Moreover, consumer acceptance of such vehicles is may be influenced by how similarly (or differently) the operation of such vehicles are when compared to conventional internal combustion vehicles.

Hybrid electric vehicles (“HEVs”) possess increased fuel economy by combining the functionality of electric vehicles with internal combustion vehicles. This combination of functionality offers the extended range and rapid refueling expected from conventional vehicles, with a significant portion of the energy and environmental benefits of an electric vehicle. The practical benefits of HEVs include improved fuel economy and lower emissions compared to internal combustion vehicles. A hybrid vehicle typically includes a high voltage battery (e.g., a battery which supplies energy or potential energy of about three hundred volts) and a relatively low voltage battery (e.g., a battery which supplies energy or potential energy of about twelve volts). The high voltage battery is typically used to operate a motor/generator which selectively provides torque to the wheels of the HEV. As in conventional vehicles, the low voltage battery provides energy to the various devices and assemblies which reside within the vehicle. Such low voltage devices include, entertainments systems (radios, CD players), communication systems (cell phones), navigation systems, and the like.

The high voltage battery must be recharged or receive electrical charge in the event that the high voltage battery becomes discharged or loses an amount of charge which causes the battery to fail to provide the necessary energy which is required to power the motor/generator assembly. Since there currently exists only a relatively small number of hybrid vehicles, the likelihood of quickly securing another high voltage battery or locating another hybrid vehicle whose high voltage battery may be used to jumpstart the disabled vehicle (by providing energy to the high voltage battery) is relatively small. Furthermore, one high voltage battery will not likely be compatible to another high voltage battery design in either hardware or electro-chemical condition and directly jumping one high voltage battery from another high voltage battery may involve hazardous operations. Not only do these conventional strategies require a high voltage battery, they continue the recharging operation until the discharged or partially discharged high voltage battery is fully charged, thereby undesirably requiring a relatively large amount of time to complete the jumpstart operation. These strategies also provide electrical energy to the high voltage battery even when the energy will not charge the high voltage battery due to a fault which may exist within the high voltage battery. Moreover, these strategies also attempt to provide electrical energy to the high voltage battery even when such energy may not be needed by the high voltage battery (e.g., such as when the high voltage battery is fully charged or has an amount of charge greatly exceeding the threshold amount of charge needed to operate the motor/generator assembly).

Related U.S. Pat. No. 6,664,757 (the '757 patent) provides a strategy of recharging the high voltage battery in HEVs. In this method, a low voltage battery is used to charge the high voltage battery. However, the method of the '757 patent requires user intervention in that a switch must be manually set to commence charging. The '757 patent provides a method which will present the user with an unfamiliar situation which does not occur in conventional internal combustion vehicles. Such a situation is somewhat undesirable if HEVs are to gain general consumer acceptance.

Accordingly, there exists a need in the prior art for a system and method for charging the high voltage battery in a hybrid electric vehicle that requires little or no user intervention.

### SUMMARY OF INVENTION

The present invention solves one or more problems of the prior art by providing in one embodiment an automatic battery charging system for selectively charging a battery in a vehicle. The automatic charging system includes a charger capable charging a first battery in a vehicle. The charge provides such charging by providing a first voltage signal to the first battery. The first voltage signal is characterized by a first voltage amplitude that is of sufficient magnitude for charging the first battery. Coupled to the charger is a controller that determines whether or not the first battery requires electrical charging. If charging is required, the controller causes the charger to automatically provide the first voltage signal to the first battery without intervention from a user. The system of the invention is particularly useful for charging the high voltage battery in an HEV with the output from a low voltage battery. Moreover, the automatic nature of the system offers improved convenience over prior art methods in which a vehicle operator must manually set a switch to initiate charging of the high voltage battery.

In another embodiment of the invention, a method of charging a first battery operatively disposed in a vehicle is provided. The method of the invention will typically be deployed by the systems set forth above. Accordingly, the vehicles in which the method is executes will have a selectively positionable ignition switch as set forth above. The method of the invention comprises determining whether the battery requires charging. If charging is necessary, electrical charge is automatically provided to the first battery when the ignition switch resides in a predetermined position without intervention by a user. The charge is typically provided by converting a second voltage signal having a second voltage amplitude to a first voltage signal having a first voltage amplitude; and providing the first voltage signal to the first battery. This charging is provided for a predetermined amount of time determined by calibration procedure.

### BRIEF DESCRIPTION OF DRAWINGS

FIG. 1 is a schematic of the automatic battery charging system of the present invention; and

FIG. 2 is a flowchart illustrating the method of the invention is which a battery is automatically recharged.

### DETAILED DESCRIPTION

Reference will now be made in detail to presently preferred compositions or embodiments and methods of the invention, which constitute the best modes of practicing the invention presently known to the inventor.

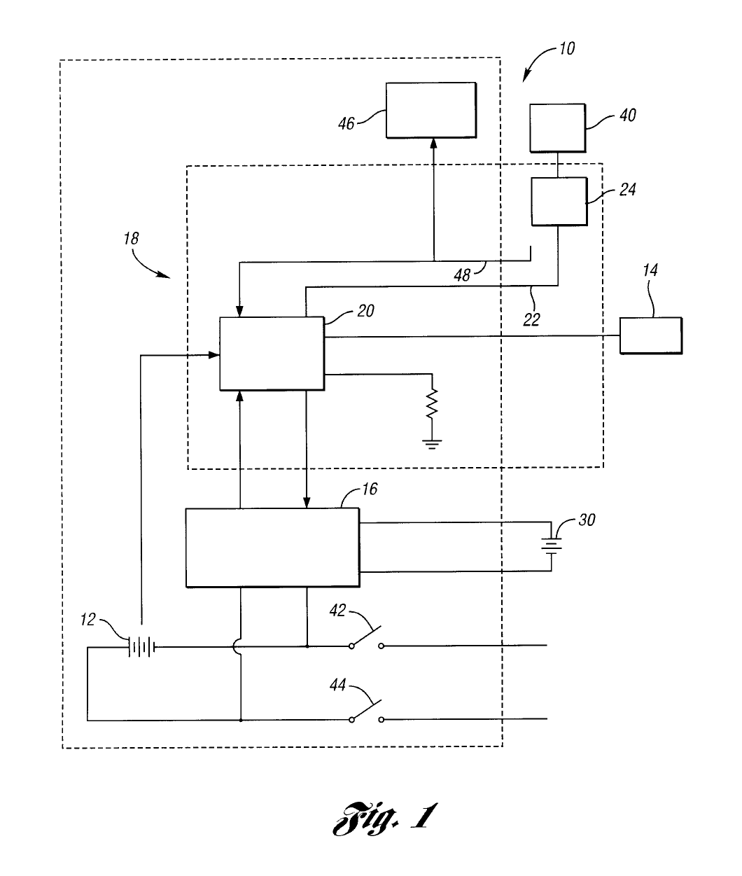

In a first embodiment, the present invention provides an automatic battery charging system for selectively charging a battery in a vehicle. With reference to FIG. 1, automatic battery charging system 10 includes first battery 12 which is operatively disposed in a vehicle. The vehicle in which automatic battery charging system 10 is used typically includes selectively positionable ignition switch 14. Typically, such an ignition switch is positionable at an “off” and “on” position. Automatic battery charging system 10 includes charger 16 capable of providing a first voltage signal to first battery 12. This first voltage amplitude is of sufficient magnitude to charge first battery 12. Automatic battery charging system 10 further includes controller 18 coupled to charger 16. Controller 18 determines whether first battery 12 requires electrical charging. If controller 18 determines that first battery 12 requires electrical charging, controller 18 causes charger 16 to automatically provide the first voltage signal to first battery 12 without intervention from a user. Controller 18 is further capable of detecting the position of ignition switch 14 such that charging of first battery 12 is only permitted when the ignition switch is in a predetermined position. Typically, this predetermined position will be the on position. The system of this embodiment provides automatic charging in that charging of first battery 12 is commenced when a charge is determined to be required without additional actions by the user beyond setting the ignition switch to a predetermined position (usually the “on” position).

Still referring to FIG. 1, when automatic battery charging system 10 is in an HEV vehicle, first battery 12 is a high voltage battery and controller 18 will include traction battery control module (“TBCM”) 20 and controller area network (“CAN”) 22. Suitable high voltage batteries are 300 V nickel-metal hydride traction battery packs commercially available from Sanyo Corporation. Such batteries are able to power an HEV in pure electric mode. Controller area network 22 is in communication with the traction battery control module 22. Addition control of the component of the system of the invention are further achieved when controller 18 also includes one or more microprocessors-base controllers 24 in communication with traction battery control module 20. Traction battery control module 20 will also include one or more timers (not shown) that allows the first battery to be charged for a predetermined time period.

Still referring to FIG. 1, charger 16 receives a second voltage signal having a second voltage amplitude from voltage source 30. Voltage source 30 is typically coupled to charger 16 such that the second voltage signal is converted into the first voltage signal. Typically, the first voltage magnitude is greater than the second voltage magnitude. Under the control and monitoring by controller 18, voltage source 30 is only provided to the first battery when the first battery requires charging. Typically, voltage source 30 is a second battery. In the typical hybrid electric vehicle application, first battery 12 is a high voltage battery capable of outputting a voltage with a higher voltage magnitude than the magnitude outputted by voltage source 30. Typical voltages will be in the range from about 150 to 350 volts (typically about 300 volts). Moreover, in the typical HEV application voltage source 30 is a low voltage battery with a output voltage in the range for about 10 to 15 volts (most typically about 12 volts).

Still referring to FIG. 1, automatic battery charging system 10 further includes system monitor 40 which is in communication with controller 16 and which provides feedback regarding charging of the first battery. A number of monitoring devices may be used as system monitor 40. For example, system monitor 40 may comprise one or more vehicle panel lights. In such a system, a light may be illuminated while the system is charging. Alternatively, system monitor 40 may be a display capable of display textual messages describing the state of the vehicle battery charging system. This latter example is more desirable since the user is given specific information and feedback as to the status of automatic battery charging system 10. Automatic battery charging system 10 also includes contactors 42, 44 which are opened by the vehicle control system when it is determined that battery 12 requires charging. Moreover, automatic battery charging system 10 also includes voltage monitor 46 which is also part of the vehicle control system. Voltage monitor 46 determines the voltage on the voltage source 30 (i.e., the low voltage 12 volt source). Line 48 represent a portion of the second voltage source bus (i.e., the low voltage bus in the vehicle). This information is used by the vehicle control system to determine whether or voltage source 30 has sufficient charge for charging battery 12.

In another embodiment of the invention, a method of charging a first battery operatively disposed in a vehicle is provided. The method of the invention will typically be deployed by the systems set forth above. Accordingly, the vehicles in which the method is executes will have a selectively positionable ignition switch as set forth above.

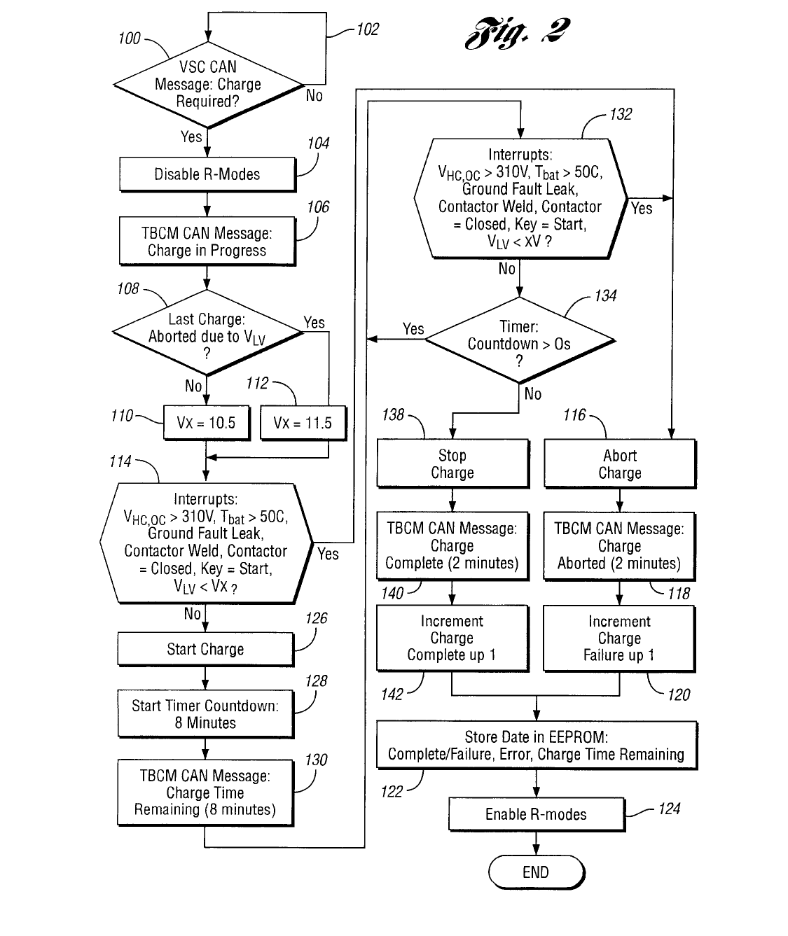

With reference to FIG. 2, a flowchart illustration the method of the invention is provided. When the vehicle fails to start upon the user turning the ignition to the “on” position, the method of the invention is invoked after several preliminary actions are taken. The vehicle control system disables all loads to the first battery (i.e., the high voltage battery in the HEV), opens the contactors, and displays a message that a charge is necessary. In block 100, a determination is made as to whether the first battery requires charging. Specifically, it is determined if the first battery requires a predetermined amount of electrical charge. If charging is not needed, the method repeated checks if charging is required as shown by feed back loop 102. If a predetermined amount of charge is necessary various battery conditioning protocols (“R modes”) are disabled as illustrated in block 104. Moreover, a message is optionally displayed on notifying the user that a charge is in progress. (block 106). Next, the status of the last charging attempt is evaluated in block 108. Specifically, if the voltage source 30 is a low voltage battery, the output voltage of the voltage source 30 is measured. If the prior charging attempt was not aborted due to a low voltage (“V_{Lv}”) from source 30, the output voltage of the voltage source 30 is compared to a first predetermined voltage value (“Vx”) as shown in block 110. Alternatively, if the prior charging attempt was aborted due to a low voltage (“V_{Lv}”) from source 30, the output voltage of the voltage source 30 is compared to a second predetermined voltage value (“Vx”) as shown in block 112. Typically, the first predetermined voltage value is less than the second predetermined voltage value. In block 114, a number of conditions are checked to determine whether or not charging should be commenced. One condition is that if the prior attempted charging was not aborted, the output voltage of the voltage source 30 is greater than the first predetermined value. If the prior charging attempt was aborted, then the output voltage of the voltage source 30 must be greater than the second predetermined value. Moreover, as shown in block 114 charging is not allowed if any of the following interrupt conditions are true: output voltage of the first battery is above a predetermined HV output, the first battery's temperature is above a predetermined temperature, presence of a potential fault condition, a contactor is closed, or ignition switch is in a predefined position (charging is typically allowed when the ignition switch is in the “on” position). If any of the interrupt conditions are true charging is aborted as shown in block 116. A message is then displayed notifying the user that charging is aborted with the remaining time necessary for completely a charge (in this case, the entire predetermined charging time) (block 118). A charge failure counter is then incremented by one to keep track of the number of aborted charges (block 120). Data which characterizes this aborted charge is store in a memory device such as a EEPROM as shown in block 122. Such data includes, for example, whether the charge was completed, the occurrence of an error, charge time remaining, and the like. Finally, any battery conditioning procedures which were disabled in block 104 are enabled (block 124).

Still referring to FIG. 2, if an interrupt condition has not occurred in block 114, charging is commenced as shown in block 126. The charging of the first battery will last for a predetermined time period. This predetermined time period will be determined by a calibration procedure in which the amount of time necessary to charge a battery is empirically determined. The countdown of this predetermined time is indicated in block 128 such that charging is sustained during this period. A status message is then displayed notifying the user how much time remains to complete the charging (block 130). During charging, the method of the invention monitors for the presence of an interrupt in the same manner as for block 114. (block 132) If an interrupt occurs, charging is aborted. (block 116) The method then proceeds to blocks 116-124 as set forth above. During normal operation in which an interrupt does not occur, a timer continues to countdown while the interrupt status is monitor (cycling through blocks 132 and 134). When the predetermined time has expired, the charging is stopped as shown in block 138. A status message notifying the user that the charge has completed is displayed along with the duration of the charging (block 130) and a charge-completed counter is incremented (block 132). Finally, the method then proceeds to blocks 120-122 as set forth above.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

1. An automatic battery charging system for selectively charging a first battery operatively disposed in a vehicle, the system comprising:
a charger capable of providing a first voltage signal having a first voltage amplitude to the first battery wherein the first voltage amplitude is of sufficient magnitude for charging the first battery; and
a controller coupled to the charger wherein the controller determines whether the first battery requires electrical charging such that if the first battery requires electrical charging the controller causes the charger to automatically provide the first voltage signal to the first battery without intervention from a user.

2. The system of claim 1 wherein the controller detects the position of the ignition switch and allows charging of the first battery when a selectively positionable ignition switch is in a predetermined position.

3. The system of claim 1 wherein the controller comprises
a traction battery control module;
a controller area network in communication with the traction battery control module; and
one or more microprocessors-base controllers in communication with the controller area network.

4. The system of claim 3 wherein the controller further comprises a timer that allows the first battery to be charged for a predetermined time period.

5. The system of claim 1 wherein the charger receives a second voltage signal having a second voltage amplitude from a voltage source and converts it to the first voltage signal.

6. The system of claim 5 wherein the voltage source is a second battery.

7. The system of claim 5 wherein the first voltage magnitude is greater than the second voltage magnitude.

8. The system of claim 7 wherein the first voltage magnitude is about 300 volts and the second voltage magnitude is about 12 volts.

9. The system of claim 1 further comprising a system monitor in communication with the control and which provides feedback regarding charging of the first battery.

10. The system of claim 9 wherein the system monitor is a vehicle panel light.

11. The system of claim 9 wherein the system monitor is a display capable of display textual messages describing the state of the vehicle battery charging system.

12. An automatic battery charging system for selectively charging a high voltage battery operatively disposed in a hybrid electric vehicle having a selectively positionable ignition switch, the system comprising:
a low voltage battery that provides a low voltage signal having a low voltage amplitude;
a charger that converts the low voltage signal into a high voltage signal having a high voltage amplitude of sufficient magnitude for charging the high voltage battery wherein the high voltage amplitude is greater than the high voltage magnitude; and
a controller coupled to the charger wherein the controller determines whether the high voltage battery requires electrical charging such that if the high voltage battery requires electrical charging the controller causes the charger to automatically provide the high voltage signal to the first battery without intervention from a user.

13. The system of claim 12 wherein the controller detects the position of the ignition switch and allows charging of the first battery when the ignition switch is in a predetermined position.

14. The system of claim 12 wherein the controller comprises
a traction battery control module;
a controller area network in communication with the traction battery control module; and
one or more microprocessors-base controllers in communication with the controller area network.

15. The system of claim 12 wherein the controller comprises a timer that allows the first battery to be charged for a predetermined time period.

16. The system of claim 12 wherein the high voltage amplitude is about 300 volts and the low voltage amplitude is about 12 volts.

17. The system of claim 12 further comprising a system monitor in communication with the controller and which provides feedback regarding charging of the first battery.

18. The system of claim 17 wherein the system monitor is a vehicle panel light.

19. The system of claim 17 wherein the system monitor is a display capable of display textual messages describing the state of the vehicle battery charging system.

20. A method of charging a first battery which is operatively disposed which a vehicle having a selectively positionable ignition switch, the method comprising:
a) determining whether the battery requires a predetermined amount of electrical charge; and
b) automatically providing electrical charge to the battery when the ignition switch resides in a predetermined position without intervention by a user.

21. The method of claim 20 wherein step b comprises converting a second voltage signal having a second voltage amplitude to a first voltage signal having a first voltage amplitude; and providing the first voltage signal to the first battery.

22. The method of claim 20 wherein the electrical charge is provided for a predetermined period of time in step b.

23. The method of claim 20 further comprising determining whether an interrupt has been set and if the interrupt has been set aborting charging of the battery.

24. The method of claim 23 wherein the interrupt is set by an interrupt condition selected from the group consisting of battery voltage exceeding a predetermined value, battery temperature exceeding a predetermined temperature, presence of a potential fault condition, ignition switch being set to a predetermined value, a low voltage signal dropping below a predetermined value, and combinations thereof.
